(19) United States
(12) Patent Application Publication
(10) Pub. No.: US 2003/0150701 A1
(43) Pub. Date: Aug. 14, 2003

(54) Modular selection button

(76) Inventors: Wilfried Küepper, Bad Neuenahr-Ahrweiler (DE); Angela Hilgers, Alfter (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/914,139

(22) PCT Filed: Dec. 13, 2000
(86) PCT No.: PCT/EP00/12638

(30) Foreign Application Priority Data
Dec. 23, 1999 (DE) 199 62 291.4

(51) Int. Cl. H01H 27/06

(52) U.S. Cl. 200/43.08

(57) ABSTRACT

The invention relates to a modular selection button for actuating contact elements. Said button comprises a housing (6), spring-loaded switching lugs (81) and according to requirements a control switch (10), a rotary knob (11) or a key-operated switch (2) as a rotating actuator, in addition to one of several transmission members (4; 4′; 5; 5′), which transmits the movement from the actuator (10; 11; 2) to the switching lugs (81) via switching cam elements (42; 52). Stops and counter-stops which are fixed and displaceable respectively with respect to the housing (6) form various stop elements that can be used to select the number of switching positions and actuation modes. The various stops are configured on the housing (6), on the key-operated actuator (2) and on the second stop slides (92) that are to be inserted into the housing (6). The various counter-stops are configured in the control switch (10), in the rotary knob (11) and on the transmission members (4; 4′; 5; 5′).

### FIELD OF THE INVENTION

The present invention relates to a modular selection button for actuating contact elements according to the definition of the species in the independent claims.

### RELATED ART

German Patent Publication DE-C2-35 41 390 describes such a selection button featuring a rotating handle, a transmission member, and stops. The essentially cylindrical transmission member is non-rotatably coupled to the handle, carries an axially acting switching cam which is closed upon itself as well as a stop boss, and is supported in a housing. To limit the angle of rotation, the stops cooperate with the stop boss and are formed in stop rings of which one is replaceably and non-rotatably arranged in the housing. Located between the stops is a circular path segment which, from stop ring to stop ring, spans a different angle and with which in each case the stop boss engages. The switching cam is configured as a projecting shoulder at the lateral surface of the transmission member and cooperates with at least one switch plunger of a contact element. The switch plunger is arranged in the housing in a manner that it is non-rotatable as well as axially movable against the action of a spring and intended to actuate the contact plunger of the contact element. The direction of rotation of the handle determines which of the two switch plungers is moved. The rotation of the handle which is limited by the respective stop ring determines, on one hand, the number of possible switching positions, that is two or three switching positions and, on the other hand, the actuation mode which is the momentary contact mode, i.e., monostable, when rotated by 45° whereas it is the latching mode, i.e., bistable, when rotated by 90°. It is a disadvantage that, for changing the actuation mode, the user has to disassemble the selection button to replace the stop ring.

### SUMMARY OF THE INVENTION

Therefore, the object of the present invention is to make changes in the actuation mode easier with and to increase the number of variants.

On the basis of a modular selection button of the type mentioned at the outset, this objective is achieved according to the present invention by the characterizing features of the independent claims while advantageous refinements of the present invention can be gathered from the dependent claims.

In the case of the first means for attaining the object of the invention, there are varied possibilities both for the type of handles to be used and for the actuation modes due to the disk-shaped design of the transmission member featuring switching cam elements projecting from the rear side and due to the formation of the permanently existing first and second stop means and the fifth stop means, which is formable as required. Finger-grip knobs, rotary knobs or equally acting actuating elements can be used as rotating handles. The selection switch can be provided with two or three switching positions and in this context, in turn, with latching or momentary contact actuation mode. Without having to be disassembled, the selection button can be easily programmed from the latching into the momentary contact actuation mode or vice versa by inserting or removing two stop slides on the rear side.

In the case of the second means for attaining the object of the invention, there are varied possibilities for the actuation modes due to the disk-shaped design of the transmission member featuring switching cam elements projecting from the rear side and due to the formation of the permanently existing third stop means and the fourth or fifth stop means, which is formable as required. More or less complex key actuators are used as rotating handles. The selection switch can be provided with two or three switching positions and in this context, in turn, with latching or momentary contact actuation mode. Moreover, it is possible for the latching actuation mode to be modified in such a manner that, in the rotated position, the key is either released such as in the resting position or retained, that is to say that it is either possible or not possible to remove the key in the rotated position. Without having to be disassembled, the selection button can be easily programmed from the latching into the momentary contact actuation mode or vice versa by inserting, removing or mutually exchanging first or second stop slides on the rear side or, when in the latching mode, from the mode with releasable key into the mode with retained key or vice versa.

In the case of the third means for attaining the object of the invention, there are varied possibilities both for the type of handles to be used and for the actuation modes due to the disk-shaped design of the transmission member featuring switching cam elements projecting from the rear side and due to the formation of the permanently existing first to third stop means and the fourth or fifth stop means, which is formable as required. Finger-grip knobs, rotary knobs, equally acting actuating elements, or more or less complex key actuators can be used as rotating handles. The selection switch can be provided with two or three switching positions and in this context, in turn, with latching or momentary contact actuation mode. When using a key actuator it is moreover possible for the latching actuation mode to be modified in such a manner that, in the rotated position, the key is either released such as in the resting position or retained, that is to say that it is either possible or not possible to remove the key in the rotated position. Without having to be disassembled, the selection button can be easily programmed from the latching into the momentary contact actuation mode or vice versa by inserting, removing or mutually exchanging first or second stop slides on the rear side or, when in the latching mode, from the mode with releasable key into the mode with retained key or vice versa. Thus, the third design approach combines all the features and advantages of the second and third design approaches.

It is advantageous for the present invention to be refined to the effect that provision is made for strip-like first or second stop slides provided with latching means, the second stop slide differing from the first stop slide only by a notch in the front part for forming the respective stop faces.

It is advantageous for the present invention to be refined to the effect that provision is made for in each case paired switch plungers and first, second, or third stops as well as first or second stop slides can be used. If the selection button is provided with three switching positions, it turns out to be expedient for this purpose to use a first transmission member having in each case mirror-symmetric pairs of switching cam elements and to use fourth counterstops; however, if the selection button is provided with two switching positions, it turns out to be expedient to use a second transmission member featuring pairs of switching cam elements and to use second counterstops whose pair elements are in each case configured to be diagonally opposed and antisymmetric, that is laterally reversed.

An advantageous development consists in sixth stop means to guarantee a definite resting position when the selection button is provided with two switching positions.

Finger-grip knobs, rotary knobs, or similar actuating elements are advantageously to be connected to the transmission member in a positive locking manner via rib- and slot-shaped segments. A further advantage follows from this in the case of two switching positions in that the handle can be connected to the transmission member in at least two engagement positions with respect to the housing. In this manner, it is possible, for example, to optionally implement either a vertical resting position and a rotated position which is angularly offset therefrom or a resting position which is angularly offset from the vertical and a rotated position of the handle which is symmetrically angularly offset therefrom.

By providing the transmission member with a light aperture, the selection button is made suitable for use with light-emitting elements.

In conjunction with a key actuator, a further advantageous development of the present invention consists in that the cylinder lock is non-rotatably connected to the housing as an additional part thereof via a cover, the lock core which can be rotated by means of the key is connected to the transmission member in a positive locking manner, and the third stop means act between the fixed cylinder lock and the transmission member.

### BRIEF DESCRIPTION OF THE DRAWINGS

Further details and advantages of the present invention follow from the following exemplary embodiment which will be explained on the basis of Figures.

FIG. 1 shows the totality of a selection button according to the present invention in a perspective, pulled-apart view; and, in each case as details from FIG. 1 in a different perspective and in an enlarged scale:

FIG. 2 shows the housing,

FIG. 3 shows the finger-grip knob,

FIG. 4 shows the key actuator,

FIG. 5 shows the first transmission member, and

FIG. 6 shows the second transmission member.

### BEST WAY OF IMPLEMENTING THE INVENTION

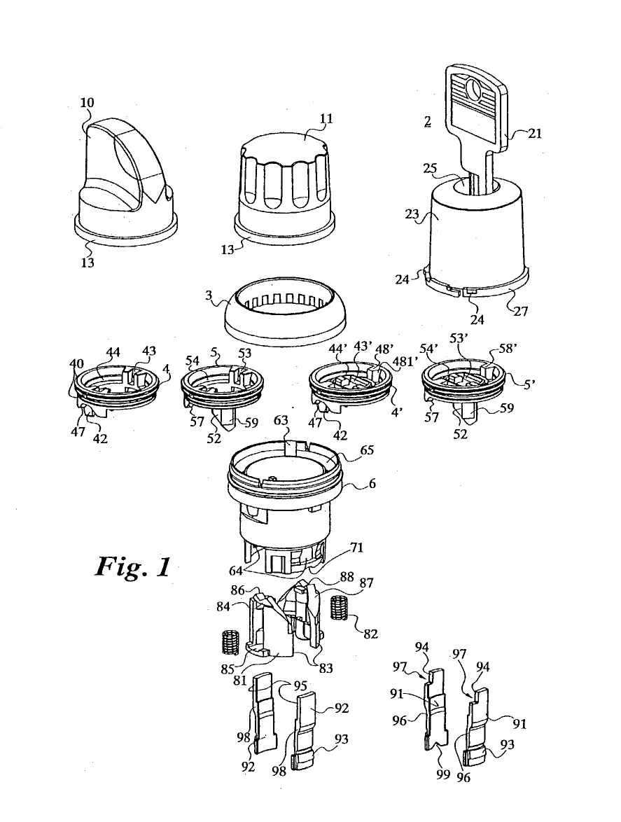

FIG. 1 shows the component parts for the totality of all three design approaches of the modular selection button according to the present invention, namely: a finger-grip knob 10, a rotary knob 11, and a key actuator 2 as a rotating handle, a front ring 3, a first transmission member 4, a second transmission member 5, a modified first transmission member 4′, a modified second transmission member 5′, a housing 6, switch plungers 81 which each have one pressure spring 82, first stop slides 91 and second stop slides 92.

In the selection button according to the first design approach, there exist, depending on the requirement, finger-grip knob 10 or rotary knob 11, front ring 3; depending on the requirement, first or second transmission member 4 or 5, housing 6, one or two switch plungers 81 with their pressure springs 82; and, depending on the requirement, none, one, or two second stop slides.

In the selection button according to the second design approach, there exist key actuator 2, front ring 3; depending on the requirement, modified first or second transmission member 4′ or 5′, housing 6, one or two switch plungers 81 with their pressure springs 82; and, depending on the requirement, none, one, or two first or second stop slides 91 or 92.

In the selection button according to the third design approach, there exist, depending on the requirement, finger-grip knob 10, rotary knob 11, or key actuator 2, front ring 3; depending on the requirement, first or second transmission member 4 or 5 or modified first or second transmission member 4′ or 5′, one or two switch plungers 81 with their pressure springs 82; and, depending on the requirement, none, one, or two first or second stop slides 91 or 92.

Since the three design approaches are equal in many features and effects, these features and effects will be described in the following for two or all of the three design approaches together, correspondingly.

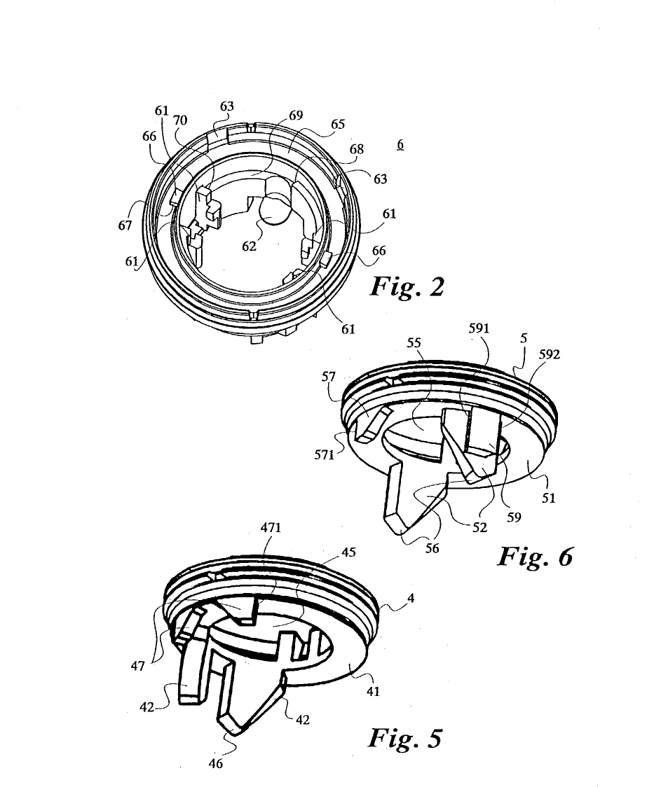

The two switch plungers 81 are inserted into housing 6 on the rear side, two widely spaced guide strips 61 in the interior of the essentially cylindrical housing 6 (FIG. 2) in each case embracing the two outer edges 83 of the respective switch plungers in a guiding and retaining manner. Helical pressure springs 82 are each braced between a first abutment 84 in switch plunger 81 and a second abutment 62 in housing 6 so that switch plungers 81 are biased in the direction of the handle by pressure springs 82. A third abutment 85 located opposite first abutment 84 in switch plunger 81 limits the movement in the direction of the handle by stopping at the rear side of second abutment 62. Disk-shaped transmission member 4, 4′, 5 or 5′, is inserted into housing 6 from the front. Subsequent to placing handle 10, 11, or 2 onto housing 6, front ring 3 is slipped over handle 10, 11, or 2 and snapped onto housing 6 at the front via usual snap-in locking elements. Thus, handle 10, 11, or 2 is connected to the housing in a manner that it cannot be lost. In this connection, finger-grip knob 10 or rotary knob 11, via a rear guide collar 13, rotatably rests in a front guide groove 65 of the housing, whereas key actuator 2, via a rear retaining collar 27, rests in the guide groove in a non-rotatable manner. Stop slides 91 and 92 have a strip-like design and, at their rear part, feature radially projecting latching means 93 via which they engage with corresponding window-like mating latching means 64 of housing 6 after being inserted from behind between two narrowly spaced guide strips 61, respectively. First transmission member 4 and second transmission member 5 are respectively provided with a centrical light aperture 45 or 55 (FIG. 5 and FIG. 6) which allows finger-grip knob 10 or rotary knob 11 to be illuminated by a light source connected to the selection button on the rear side. Transmission members 4, 4′, 5 and 5′ are equipped with ring-shaped seals 40 on the edges which protect the interior of the selection button from entering moisture and compensate for tolerances between the movable parts.

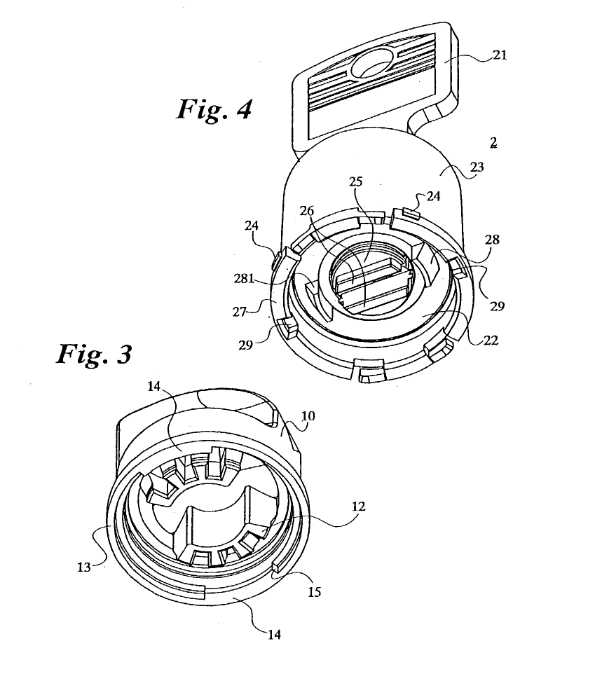

According to FIG. 1 and FIG. 5 or FIG. 6, two axially projecting switching cam elements 42 or 52 are respectively formed on rear side 41 or 51 of first transmission member 4 or 4′ or of the second transmission member 5 or 5′, the switching cam elements cooperating with front end faces 86 of switch plungers 81 in such a manner that, when transmission member 4, 4′, 5 or 5′ is rotated out of its resting position, switch plungers 81 are moved toward the rear against the action of pressure springs 82 for actuating contact elements which are not shown. Formed on finger-grip knob 10 and on rotary knob 11 on the rear side are mutually opposing rib segments 12 (FIG. 3) which engage in a positive-locking manner with correspondingly configured mutually opposing slot segments 43 on front side 44 of first transmission member 4 or in slot segments 53 on front side 54 of second transmission member 5 during the placement of finger-grip knob 10 or rotary knob 11. In this manner, a rotary motion of finger-grip knob 10 or rotary knob 11 is transmitted to first or second transmission member 4 or 5, respectively.

According to FIG. 1 and FIG. 4, key actuator 2 is composed of a key 21 and a cylinder lock 22 which is fixed in a cover 23 in a positive locking and therefore unrotatable manner. Cover 23 features two noses 24 on the edge of its collar 27, and housing 6 has two correspondingly configured grooves 63 in the upper edge area, via which grooves cover 23, in turn, is mounted in housing 6 in its correct position. Diametrically opposing recesses 29 on the rear side of collar 27, in cooperation with first stops 66 in guide groove 65 of housing 6, guarantee the non-rotatability of cover 6 with cylinder lock 22 in housing 6. Lock core 25, which is to be rotated by means of the key, features two strip-like formations 26 on its rear side, the strip-like formations engaging in a positive locking manner with correspondingly configured recesses 43′ or 53′ on front side 44′ or 54′ of modified first or second transmission member 4′ or 5′, respectively. In this manner, a rotary motion is transmitted from key 21 to modified first or second transmission member 4′ or 5′, respectively.

When using finger-grip knob 11 or rotary knob 11 as a handle, the selection button can be provided with three switching positions, namely with a middle resting position as well as one clockwise and one counterclockwise rotated position, respectively. In the case of this variant, first transmission member 4 shown in FIG. 1 and FIG. 5 is used whose switching cam elements 42 mutually oppose each other at an acute angle. In the resting position, switching cam elements 42 are situated in the middle between the two switch plungers 81. When rotating finger-grip knob 10 or rotary knob 11 in one or in the other direction, in each case one of the two switching cam elements 42 applies pressure to an in each case abutting slanted surface 87 of end face 86 of appertaining switch plunger 81 against its pressure spring 82. If no stop slides are inserted, specific switching cam element 42, with its cam tip 46, reaches the region of a latching recess 88 of end face 86 of appertaining switch plunger 81. The selection button remains in this latched rotated position until it is removed from this position by an intentional actuation. To limit the angle of rotation in both directions, provision is made for first stop means which are composed of two diametrically opposing first stops 66 which are formed in guide groove 65 of housing 6 in a nose-shaped manner and directed radially outward and of two diametrically opposing first counterstops 14 which are formed on guide collar 13 of finger-grip knob 10 or of rotary knob 11 as ring segments in a manner that they are directed radially inward, the both radially and axially running side faces 67 of first stops 66 cooperating with corresponding side faces 15 of first counterstops 14, respectively.

By inserting second stop slides 92 into housing 6, provision is made for fifth stop means which take effect before the first stop means when the selection button is rotated out of the resting position. The fifth stop means are composed of diametrically opposing second stop faces 95 which are formed by the front part of narrow side 98 of formed second stop slides 92 which narrow side opposes the respective direction of rotation, and of two fourth counterstops 47 which are formed on rear side 41 of first transmission member 4 in a manner that they project radially and symmetrically oppose each other at an acute angle, second stop faces 95 cooperating with the both radially and axially running edge faces 471 of counterstops 47 which are angularly offset from switching cam elements 42. In this manner, the angle of rotation of the selection button is limited so that it is no longer possible for the respective switching cam element 42 to reach, with its cam tip 46, the region of latching recess 88 of end face 86 of appertaining switch plunger 81. In this case, the selection button features the momentary contact mode in both rotated positions since, after releasing handle 10 or 11, the selection button automatically returns from the rotated position to the resting position through the action of pressure springs 82 and the interplay of slanted surfaces 87 of switch plungers 81 with switching cam elements 42.

When using finger-grip knob 10 or rotary knob 11 as a handle, the selection button can also be provided with two switching positions, namely with a resting position and a clockwise rotated position. In the case of this variant, second transmission member 5 shown in FIG. 1 and FIG. 6 is used whose switching cam elements 52 diametrically oppose each other in a manner that they are laterally reversed, i.e., offset by 180°. In the resting position, switching cam elements 52 in each case abut on the slanted surface 87 of the two switch plungers 81 which runs ahead in the direction of rotation. When rotating finger-grip knob 10 or rotary knob 11, each of the two switching cam elements 52 applies pressure to respective slanted surface 87 of appertaining switch plunger 81 against its pressure spring 82. If no stop slides are inserted, specific switching cam element 52, with its cam tip 56, reaches the region of a latching recess 88 of end face 86 of appertaining switch plunger 81. In this manner, the rotated position is latched. To limit the angle of rotation, provision is made for second stop means which are composed of two diametrically opposing second stops 68 which each occur in the clockwise direction as end face of two sector-shaped recesses 69 diametrically formed in housing 6 and of two diametrically opposing second counterstops 59 which are formed on rear side 51 of second transmission member 5 in a manner that they project axially and oppose each other diametrically and that they are arranged radially outward in front of one of the switching cam elements 52, respectively, second stops 68 cooperating with corresponding edges 591 of second counterstops 59, the edges running ahead in the direction of rotation. For assuming the resting position which is brought about by pressure springs 82 and by the interplay of slanted surfaces 87 of switch plungers 81 with switching cam elements 52, the selection button is equipped with sixth stop means which are composed of fourth stops 70 which each occur in the counterclockwise direction as end face of two sector-shaped recesses 69 and of second counterstops 59, fourth stops 70 cooperating with corresponding edges 592 of second counterstops 59, the edges running after.

To implement the momentary contact operating mode, provision is made for fifth stop means, again by inserting a second stop slide 92 into housing 6, the fifth stop means taking effect before the second stop means when the selection button is rotated out of the resting position. In this case, the fifth stop means are composed of second stop face 95 of the only stop slide 92 and of a fourth counterstop 57, which is formed on rear side 51 of second transmission member 5 in a manner that it projects axially, second stop face 95 cooperating with the both radially and axially running edge face 571 of counterstop 57, which counterstop is angularly offset from switching cam elements 52. In this manner, the angle of rotation of the selection button is limited so that it is no longer possible for the switching cam elements 52 to reach, with their cam tip 56, the region of latching recesses 88 of end faces 86 of appertaining switch plungers 81.

Finger-grip knob 10 is provided with a number of rib segments 12 greater than the number of slot segments 53 of second transmission member 5. Because of this, it is possible for finger-grip knob 10 to be optionally brought into two different engagement positions with first transmission member 5. In the case of a horizontal fitting position of a selection button provided with two switching positions, finger-grip knob 10 will assume a vertical resting position (0°) in the one engagement position, and a rotated position which is angularly offset therefrom (for example, +30°) whereas, in the other engagement position, the finger-grip knob will assume a resting position which is angularly offset with respect to the vertical (for example, −15°) and a rotated position which is symmetrically angularly offset therefrom (for example, +15°).

When using key actuator 2 as a handle, the selection button can be provided with three switching positions again. In this variant, modified first transmission member 4′ shown in FIG. 1 is used whose switching cam elements 42 and fourth counterstops 47 are formed identically as in above described first transmission member 4. Without a latching slide, the latching actuation mode is implemented again, the full angle of rotation being reached here, allowing key 21 to be released or removed in the rotated positions. To dimension the full angle of rotation in both directions, provision is made for third stop means which are composed of two diametrically opposing third stops 28 which are formed on the rear side of stationary cylinder lock 22 as ring segments and in an axial direction, and of two diametrically opposing third counterstops 48′ which are formed on front side 44′ of modified first transmission member 4′ in a nose-shaped manner and directed radially inward, corresponding radially and axially running side faces 281 of third stops 28 cooperating with corresponding side faces 481′ of third counterstops 48′.

In this case, fourth counterstops 47 of first modified transmission member 4′, together with second stop faces 95 of second stop slides 92 which are inserted in housing 6, form the fifth stop means for implementing the momentary contact actuation mode. Because of the limited angle of rotation, it is not possible for key 21 to be removed in the rotated positions.

By inserting first stop slides 91 in lieu of second stop slides 92, provision is made for fourth stop means which, when key actuator 2 is rotated out of the resting position, are effective already before the third stop means but after the above described fifth stop means. In this manner, again, a latching actuation mode is implemented, however, due to the still limited angle of rotation, key 21 cannot be removed in the rotated position here either since it is retained in cylinder lock 22 because of the failure to reach the full angle of rotation. The fourth stop means are composed of mutually opposing first stop faces 94 which are formed by the in each case rear surface of a notch 97 located at the front part of narrow side 96 of first stop slides 91 which narrow side opposes the respective direction of rotation, and of fourth counterstops 47 of modified first transmission member 4′. The two stop slides 91 have a mirror-symmetric design with respect to their narrow sides 96 as axis of symmetry and differ from second stop slides 92 essentially by notches 97. One of the two first stop slides 91 is coded at the rear part with a first indentation 99 which corresponds to a second indentation 71 underneath one of mating latching means 64 in housing 6 to enable each of the two mirror-symmetric fist stop slides 91 to be placed to the correct location of housing 6.

When using key actuator 2 as a handle, the selection button can also be provided with two switching positions. In this variant, modified second transmission member 5′ shown in FIG. 1 is used whose switching cam elements 52, second counterstops 59, and fourth counterstop 57 are formed identically as in above described second transmission member 4. Again, key 21 is released in the rotated position with no latching slide being inserted. In the case of a latched rotated position and releasable key 21, again, the movement is limited by the third stop means, which are formed by third stops 28 located at cylinder lock 22 and by third counterstops 58′, which are formed on front side 54′ of modified second transmission member 5′ and which correspond to counterstops 48′ of modified first transmission member 4′. Here too, the limiting in the resting position is brought about by the sixth stop means including fourth stops 70 in housing 6 and second counterstops 59.

By inserting only one first stop slide 91 into housing 6, in cooperation with fourth counterstop 57 of modified second transmission member 5′, again, provision is made for the fourth stop means which, in cooperation with cylinder lock 22, retain key 21 in the latched rotated position.

Here too, the limitation of the rotary motion in the momentary contact actuation mode is carried out by the fifth stop means including the only second stop slide 92 and fourth counterstop 57.

The present invention is not limited to the specific embodiments described above but includes all equally-acting embodiments along the lines of the present invention. Instead of the described handles, it is also possible to use other equally-acting handles such as an actuating rod which is appropriately formed at the end face and capable of being directly engaged with recesses 43′ or 53′ of modified first or second transmission member 4′ or 5′ from the front and able to be removed therefrom again. In the case of a selection button provided with three switching positions, it is also possible to use only one first stop slide 91 alone, one second stop slide 92 alone or one first and one second stop slide 91 and 92 together to implement the latching or momentary contact actuation mode only in only one corresponding direction of rotation, possibly with releasable or retained key. The embodiment of the present invention can be simplified for certain applications by using only one switch plunger 81. A simplification at the cost of reliability can also be given in that in each case only one first, second and third stop 66, 68 or 28, respectively, are formed.

### LIST OF REFERENCE NUMERALS

10 finger-grip knob

11 rotary knob

12 rib segments

13 guide collar

14 first counterstop

15 side face

2 key actuator

21 key

22 cylinder lock

23 cover

24 noses

25 lock core

26 formations

27 retaining collar

28 third stop

281 side face

29 recess

3 front ring

4 first transmission member

40 seals

41 rear side

42 switching cam elements

43 slot segments

44 front side

45 light aperture

46 cam tip

47 fourth counterstop

471 edge face

4′ modified first transmission member

43′ recesses

44′ front side

48′ third counterstop

481′ side face

5 second transmission member

51 rear side

52 switching cam elements

53 slot segments

54 front side

55 light aperture

56 cam tip

57 fourth counterstop

571 edge face

59 second counterstop

591 edge running ahead

592 edge running after

5′ modified second transmission member

53′ recesses

54′ front side

58′ third counterstop

6 housing

61 guide strips

62 second abutment

63 grooves

64 mating latching means

65 guide groove

66 first stop

67 side face

68 second stop

69 recess

70 fourth stop

71 second indentation

81 switch plunger

82 pressure spring

83 outer edges

84 first abutment

85 third abutment

86 end face

87 slanted surface

88 latching recess

91 first stop slide

92 second stop slide

93 latching means

94 first stop face

95 second stop face

96 narrow side

97 notch

98 narrow side

99 first indentation

What is claimed is:

1. A modular selection button for actuating contact elements comprising
1 a housing (6);
2 a finger-grip knob (10), a rotary knob (11) or the like as rotating handle;
3 a transmission member (4; 5) which is non-rotatably coupled to the handle (10; 11) and supported in the housing (6) and carries an axially acting switching cam;
4 stop means including stops which are fixed relative to the housing (6) and counterstops which can be rotated using the handle (10; 11) and which serve for limiting the angle of rotation of the handle (10; 11);
5 at least one switch plunger (81) which is supported in the housing (6) in a manner that it is non-rotatable as well as axially movable against spring means (82) and which cooperates frontward with the switching cam via a symmetrically formed end face (86), the switching cam and the end face (86) being designed in such a manner that the transmission member (4; 5) latches onto the switch plunger (81) when a specific angle of rotation with respect to the resting position is reached;
wherein
3.1 the transmission member (4; 5) has a disk-shaped design and carries axially projecting switching cam elements (42; 52) on the rear side (41; 51);
4.1 when working with a latching rotated position with respect to the resting position, the stop means which act for the specific direction are:
4.1.1.1 in the case of three switching positions: first stop means including a first stop (66) in the housing (6) and a first counterstop (14) in the handle (10; 11),
4.1.1.2 on the other hand, in the case of two switching positions: second stop means including a second stop (68) in the housing (6) and a second counterstop (59) on the transmission member (5);
4.2 when working with a momentary-contact rotated position with respect to the resting position, the stop means which act for the specific direction are: fifth stop means including a second stop slide (92) which is to be inserted into the housing (6) in a latchable manner and a fourth counterstop (47; 57) on the transmission member (4; 5), the angular distance in the direction of rotation between the decisive second stop face (95) of the second stop slide (92) and the fourth counterstop (47; 57) being smaller than the angular distance between the first or the second stop means (66, 16; 68, 59), respectively.

2. A modular selection button for actuating contact elements comprising
1 a housing (6);
2 a rotating handle (2);
3 a transmission member (4′; 5′) which is non-rotatably coupled to the handle (2) and supported in the housing (6) and carries an axially acting switching cam;
4 stop means including stops which are fixed relative to the housing (6) and counterstops which can be rotated using the handle (2) and which serve for limiting the angle of rotation of the handle (2);
5 at least one switch plunger (81) which is supported in the housing (6) in a manner that it is non-rotatable as well as axially movable against spring means (82) and which cooperates frontward with the switching cam via a symmetrically formed end face (86), the switching cam and the end face (86) being designed in such a manner that the transmission member (4′; 5′) latches onto the switch plunger (81) when a specific angle of rotation with respect to the resting position is reached;
wherein
2.1 the handle is a key actuator (2);
3.1 the transmission member (4′; 5′) has a disk-shaped design and carries axially projecting switching cam elements (42; 52) on the rear side (41; 51),
4.1 when working with a latching rotated position with respect to the resting position, the stop means which act for the specific direction are:
4.1.2.1 with key (21) being releasable in the rotated position: third stop means including a third stop (28) which is fixed with respect to the housing (6) and a third counterstop (48′; 58′) on the transmission member (4′; 5′),
4.1.2.2 on the other hand, with key (21) being retained in the rotated position: fourth stop means including a first stop slide (91) to be inserted, in a latchable manner from behind, into the housing (6) which is open on the rear side and a fourth counterstop (47; 57) on the transmission member (4′; 5′), the angular distance in the direction of rotation between the decisive first stop face (94) of the first stop slide (91) and the fourth counsterstop (47; 57) being somewhat smaller than the angular distance between the third stop means (28, 48′; 28, 58′);
4.2 when working with a momentary-contact rotated position with respect to the resting position, the stop means which act for the specific direction are: fifth stop means including a second stop slide (92) which, in lieu of the first stop slide (91), is to be inserted into the housing (6) in a latchable manner and the fourth counterstop (47; 57) on the transmission member (4′; 5′), the decisive second stop face (95) of the second stop slide (92) being positioned before the first stop face (94) of the first stop slide (91) in the direction of rotation.

3. A modular selection button for actuating contact elements comprising
1 a housing (6);
2 a rotating handle (10; 11; 2);
3 a transmission member (4; 4′; 5; 5′) which is non-rotatably coupled to the handle (10; 11; 2) and supported in the housing (6) and carries an axially acting switching cam;
4 stop means including stops which are fixed relative to the housing (6) and counterstops which can be rotated using the handle (10; 11; 2) and which serve for limiting the angle of rotation of the handle (10; 11; 2);
5 at least one switch plunger (81) which is supported in the housing (6) in a manner that it is non-rotatable as well as axially movable against spring means (82) and which cooperates frontward with the switching cam via a symmetrically formed end face (86), the switching cam and the end face (86) being designed in such a manner that the transmission member (4; 4′; 5; 5′) latches onto the switch plunger (81) when a specific angle of rotation with respect to the resting position is reached;
wherein
3.1 the transmission member (4; 4′; 5; 5′) has a disk-shaped design and carries axially projecting switching cam elements (42; 52) on the rear side (41; 51),
4.1 when working with a latching rotated position with respect to the resting position, the stop means which act for the specific direction are:
4.1.1 when using a finger-grip knob (10), a rotary knob (11) or the like as rotating handle,
4.1.1.1 in the case of three switching positions: first stop means including a first stop (66) in the housing (6) and a first counterstop (14) in the handle (10; 11),
4.1.1.2 on the other hand, in the case of two switching positions: second stop means including a second stop (68) in the housing (6) and a second counterstop (59) on the transmission member (5),
4.1.2 however, when using a key actuator (2) as rotating handle,
4.1.2.1 and with key (21) being releasable in the rotated position: third stop means including a third stop (28) which is fixed with respect to the housing (6) and a third counterstop (48′; 58′) on the transmission member (4′; 5′),
4.1.2.2 on the other hand, with key (21) being retained in the rotated position: fourth stop means including a first stop slide (91) to be inserted, in a latchable manner from behind, into the housing (6) which is open on the rear side and a fourth counterstop (47; 57) on the transmission member (4′; 5′), the angular distance in the direction of rotation between the decisive first stop face (94) of the first stop slide (91) and the fourth counsterstop (47; 57) being somewhat smaller than the angular distance between the third stop means (28, 48′; 28, 58′);
4.2 when working with a momentary-contact rotated position with respect to the resting position, the stop means which act for the specific direction are: fifth stop means including a second stop slide (92) which, in lieu of the first stop slide (91), is to be inserted into the housing (6) in a latchable manner and the fourth counterstop (47; 57) on the transmission member (4; 4′; 5; 5′), the decisive second stop face (95) of the second stop slide (92) being positioned before the first stop face (94) of the first stop slide (91) in the direction of rotation.

4. The modular selection button as recited in claim 1,
wherein the second stop slide (92) has a strip-like design;
its front part is provided with the stop face (95) at the narrow side (98) with respect to the direction of rotation of the handle (10; 11); and
the second stop slide, at its rear part, features latching means (93) for engaging with corresponding mating latching means (64) of the housing (6).

5. The modular selection button as recited in claim 2 or 3,
wherein the first and second stop slides (91; 92) have a strip-like design;
their front part is provided with the stop face (94; 95) at the narrow side (96; 98) with respect to the direction of rotation of the handle (10; 11; 2); and
the first and second stop slides, at their rear part, feature latching means (93) for engaging with corresponding mating latching means (64) of the housing (6);
and wherein the first stop slide (91), as opposed to the second stop slide (92), is provided with a notch (97) in the front part for forming the first stop face (94).

6. The modular selection button as recited in claim 1,
wherein in the housing (6), in each case diametrically opposing each other, two identical switch plungers (81) are guided, two identical first and second stops (66; 68) are formed, and two identical mating latching means (64) for the second stop slides (92) are formed.

7. The modular selection button as recited in claim 2,
wherein in the housing (6), in each case diametrically opposing each other, two identical switch plungers (81) are guided, two identical third stops (28) are formed, and two identical latching means (64) for the first and second stop slides (91; 92) are formed.

8. The modular selection button as recited in claim 3,
wherein in the housing (6), in each case diametrically opposing each other, two identical switch plungers (81) are guided, two identical first, second and third stops (66; 68; 28) are formed, and two identical latching means (64) for the first and second stop slides (91; 92) are formed.

9. The modular selection button as recited in one of the claims 6 through 8,
wherein, for three switching positions, provision is made for a first transmission member (4; 4′) on whose rear side (41) are formed both switching cam elements (42) and, angularly offset therefrom, both fourth axially projecting counterstops (47), in each case in a manner that they are symmetrically offset from each other by an acute angle.

10. The modular selection button as recited in one of the claims 6 through 8,
wherein, for two switching positions, provision is made for a second transmission member (5; 5′) on whose rear side (51) are formed both switching cam elements (52) and both second axially projecting counterstops (59), in each case in a manner that they are offset from each other by 180°.

11. The modular selection button as recited in one of the preceding claims,
wherein, for the resting position, provision is made for sixth stop means including two diametrically opposing fourth stops (70) in the housing (6) and the second counterstops (59).

12. The modular selection button as recited in claim 1 or 3,
wherein rib segments (12) which are formed on the rear side of the handle, which is designed as finger-grip knob (10), rotary knob (11) or the like, engage in a positive-locking manner with slot segments (43; 53) which are formed on the front side of the transmission member (4; 5).

13. The modular selection button as recited in claim 12,
wherein at least two engagement positions of the handle (10; 11) with the second transmission member (4; 5) exist, the engagement positions being offset from each other.

14. The modular selection button as recited in claim 1 or 3,
wherein the transmission member (4; 5) is provided with a light aperture (45; 55).

15. The modular selection button as recited in claim 2 or 3,
wherein, when using a key actuator (2) as rotating handle, a cylinder lock (22) is non-rotatably connected to the housing (6) via a cover (23);
strip-like formations (26) on the rear side of the rotatable lock core (25) engage in a positive locking manner with recesses (43′; 53′) on the front side of a modified transmission member (4′; 5′);
the third stop (28) is formed on the rear side of the cylinder lock (22) and the third counterstop (48′; 58′) is formed on the front side of the modified transmission member (4′; 5′).
